(19) United States
(12) Patent Application Publication
(10) Pub. No.: US 2023/0306293 A1
(43) Pub. Date: Sep. 28, 2023

(54) QUANTUM CIRCUIT GENERATION DEVICE, QUANTUM CIRCUIT GENERATION METHOD, AND QUANTUM CIRCUIT GENERATION PROGRAM

(71) Applicant: The University of Tokyo, Tokyo (JP)

(72) Inventors: Shunsuke DAIMON, Tokyo (JP); Eiji SAITOH, Tokyo (JP)

(21) Appl. No.: 18/022,097

(22) PCT Filed: Aug. 18, 2021
(86) PCT No.: PCT/JP2021/030135

§ 371 Date: Feb. 17, 2023

(30) Foreign Application Priority Data
Aug. 20, 2020 (JP) 2020-139201

(51) Int. Cl. G06N 10/20; G06N 3/092

(52) U.S. Cl. CPC G06N 10/20; G06N 3/092

(57) ABSTRACT

A quantum circuit generation device 10 includes a setting unit 11 which sets a reference quantum circuit including multiple quantum operations to be performed on multiple qubits, and a generation unit 13 which generates a shortened quantum circuit including quantum operations smaller in number than the quantum operations included in the reference quantum circuit, where the shortened quantum circuit is so evaluated that a probability distribution obtained when quantum operations by the shortened quantum circuit are performed on the multiple qubits approximates to a probability distribution obtained when quantum operations by the reference quantum circuit are performed on the multiple qubits.

### CROSS-REFERENCE TO RELATED APPLICATION

This application is based on Japanese Patent Application No. 2020-139201, filed Aug. 20, 2020, the entire contents of which are incorporated herein by reference.

### TECHNICAL FIELD

The present invention relates to a quantum circuit generation device, a quantum circuit generation method, and a quantum circuit generation program.

### BACKGROUND ART

In recent years, quantum computers capable of manipulating several tens of qubits have been used, and research to reduce the effects of noise caused in the processes of quantum state initialization, quantum operation, and quantum measurement has been ongoing. Like quantum computers used in recent years, quantum computers on the assumption of being affected by noise are called NISQ (Noisy Intermediate-Scale Quantum) devices.

In order to reduce the effects of noise, for example, in Non-Patent Document 1 and Non-Patent Document 2, researches to learn quantum state control methods using reinforcement learning are described. Further, in Non-Patent Document 3, research to generate quantum gate sequences for quantum error correction using reinforcement learning is described.

Further, in Non-Patent Document 4 and Non-Patent Document 5, researches to optimize microwave pulse shapes for realizing quantum gates by machine learning are described. Further, in Non-Patent Document 6 and Non-Patent Document 7, researches to perform machine learning using quantum computers for neural networks are described.

### CITATION LIST

### Non-Patent Document

Non-Patent Document 1: Chunlin Chen, Daoyi Dong, Han-Xiong Li, Jian Chu, and Tzyh-Jong Tarn, “Fidelity-Based Probabilistic Q-Learning for Control of Quantum Systems,” IEEE Transactions on Neural Networks and Learning Systems, Volume 25, Issue 5, 2014
Non-Patent Document 2: Marin Bukov, Alexandre G. R. Day, Dries Sels, Phillip Weinberg, Anatoli Polkovnikov, and Pankaj Mehta, “Reinforcement Learning in Different Phases of Quantum Control,” Phys. Rev. X 8, 031086, 2018
Non-Patent Document 3: Thomas Fosel, Petru Tighineanu, Talitha Weiss, and Florian Marquardt, “Reinforcement Learning with Neural Networks for Quantum Feedback,” Phys. Rev. X 8, 031084, 2018
Non-Patent Document 4: Nikolaj Moll, Panagiotis Barkoutsos, Lev S. Bishop, Jerry M. Chow, Andrew Cross, Daniel J. Egger, Stefan Filipp, Andreas Fuhrer, Jay M. Gambetta, Marc Ganzhorn, “Quantum optimization using variational algorithms on near-term quantum devices,” Quantum Science and Technology, Volume 3, Number 3, 2018
Non-Patent Document 5: Navin Khaneja, Timo Reiss, Cindie Kehlet, Thomas Schulte-Herbruggen, and Steffen J. Glaser, “Optimal control of coupled spin dynamics: design of NMR pulse sequences by gradient ascent algorithms,” Journal of Magnetic Resonance, Volume 172, Issue 2, Pages 296-305, 2005
Non-Patent Document 6: K. Mitarai, M. Negoro, M. Kitagawa, and K. Fujii, “Quantum circuit learning,” Phys. Rev. A 98, 032309, 2018
Non-Patent Document 7: Vojtech Havlicek, Antonio D. Corcoles, Kristan Temme, Aram W. Harrow, Abhinav Kandala, Jerry M. Chow, and Jay M. Gambetta, “Supervised learning with quantum-enhanced feature spaces,” Nature, volume 567, pages 209-212, 2019

### SUMMARY

### Technical Problem

However, the number of quantum gate operations practically executable by a NISQ device is limited to about dozens of times as yet due to the effects of noise. Therefore, although quantum supremacy is confirmed and it is industrially important, it is difficult to execute such a quantum algorithm as to require more quantum gate operations on the NISQ device.

Therefore, it is an object of the present invention to provide a quantum circuit generation device, a quantum circuit generation method, and a quantum circuit generation program for generating a shortened quantum circuit capable of obtaining computation results similar to those of such a quantum algorithm as to require many quantum gate operations on a NISQ device.

### Solution to Problem

A quantum circuit generation device according to one aspect of the present invention includes: a setting unit which sets a reference quantum circuit including multiple quantum operations to be performed on multiple qubits; and a generation unit which generates a shortened quantum circuit including quantum operations smaller in number than the quantum operations included in the reference quantum circuit, where the shortened quantum circuit is so evaluated that a probability distribution obtained when quantum operations by the shortened quantum circuit are performed on the multiple qubits approximates to a probability distribution obtained when quantum operations by the reference quantum circuit are performed on the multiple qubits.

According to this aspect, the shortened quantum circuit smaller in the number of quantum operations than the reference quantum circuit that executes a desired quantum algorithm can be generated to obtain the probability distribution approximate to the probability distribution obtained when quantum operations are performed by the reference quantum circuit to measure the multiple qubits, and computation results similar to those of such a quantum algorithm as to require many quantum gate operations on a NISQ device can be obtained with fewer quantum gate operations. Since the effect of noise is roughly proportional to the number of quantum gate operations, more accurate computation results can be obtained by the shortened quantum circuit performing quantum operations rather than by the reference quantum circuit performing quantum operations on the NISQ device.

In the above aspect, the evaluation in the generation unit may be made by generating multiple intermediate quantum circuits including quantum operations smaller in number than the quantum operations included in the reference quantum circuit, and exploring the shortened quantum circuit from among the multiple intermediate quantum circuits based on an evaluation function in which a probability distribution obtained when quantum operations by the multiple intermediate quantum circuits are performed on the multiple qubits, and the number of quantum operations included in the multiple intermediate quantum circuits are set as variables.

According to this aspect, a desired quantum algorithm can be executed by a shorter quantum circuit more accurately.

In the above aspect, the quantum circuit generation device may further include a reinforcement learning unit which generates an agent by reinforcement learning to output one or more quantum operations to be performed on the multiple qubits so as to obtain a probability distribution that approximates to a probability distribution obtained when quantum operations by the reference quantum circuit are performed on the multiple qubits, wherein the generation unit generates the shortened quantum circuit based on the one or more quantum operations output by the agent, and the reinforcement learning unit generates the agent by setting one or more quantum operations performed on the multiple qubits as state, setting quantum operations to be performed on the multiple qubits as action, and calculating a reward based on a degree of coincidence between a probability distribution obtained when quantum operations by the reference quantum circuit are performed on the multiple qubits and a probability distribution obtained when the one or more quantum operation selected as the action are performed on the multiple qubits.

According to this aspect, even when the number of combinations of quantum operations capable of being approximate to the reference quantum circuit is huge, a suitable combination of quantum operations can be explored efficiently using reinforcement learning.

In the above aspect, the generation unit may determine whether or not to end the selection of the action by the agent based on the reward calculated by comparing the degree of coincidence with a threshold value.

According to this aspect, a relatively short quantum circuit can be generated while increasing the degree of coincidence sufficiently.

In the above aspect, the degree of coincidence may be given as a function in which a probability distribution obtained when quantum operations by the reference quantum circuit are performed on the multiple qubits, and a probability distribution obtained when the one or more quantum operations selected as the action are performed on the multiple qubits are set as variables.

According to this aspect, a reward of reinforcement learning can be set properly to facilitate the progress of learning.

In the above aspect, the function may include Kolmogorov distance or Bhattacharyya coefficient.

In the above aspect, the agent may select the action using Monte Carlo Tree Search.

According to this aspect, shorter sequences of quantum gate operations capable of obtaining a probability distribution that approximates to a probability distribution obtained when quantum operations by the reference quantum circuit are performed on the multiple qubits can be generated.

In the above aspect, the agent may perform the Monte Carlo Tree Search based on output values obtained by inputting the state to a neural network.

According to this aspect, shorter sequences of quantum gate operations capable of obtaining a probability distribution that approximates to a probability distribution obtained when quantum operations by the reference quantum circuit are performed on the multiple qubits can be generated more efficiently.

In the above aspect, the generation unit may update parameters of the neural network based on learning data obtained by simulating selection of the action using the Monte Carlo Tree Search and calculation of the reward multiple times.

According to this aspect, the state can be evaluated by the neural network more properly, and hence more proper action can be selected.

In the above aspect, the generation unit may calculate the reward based on the degree of coincidence and the number of one or more quantum operations included in the state.

According to this aspect, the agent to generate a shorter quantum circuit with a higher degree of coincidence can be generated by reinforcement learning.

A quantum circuit generation method according to another aspect of the present invention includes: setting a reference quantum circuit including multiple quantum operations to be performed on multiple qubits; and generating a shortened quantum circuit including quantum operations smaller in number than the quantum operations included in the reference quantum circuit, where the shortened quantum circuit is so evaluated that a probability distribution obtained when quantum operations by the shortened quantum circuit are performed on the multiple qubits approximates to a probability distribution obtained when quantum operations by the reference quantum circuit are performed on the multiple qubits.

According to this aspect, the shortened quantum circuit smaller in the number of quantum operations than the reference quantum circuit that executes a desired quantum algorithm can be generated to obtain the probability distribution approximate to the probability distribution obtained when quantum operations are performed by the reference quantum circuit to measure the multiple qubits, and computation results similar to those of such a quantum algorithm as to require many quantum gate operations on a NISQ device can be obtained.

A quantum circuit generation program according to still another aspect of the present invention causes a classical arithmetic circuit included in a quantum circuit generation device to execute: setting a reference quantum circuit including multiple quantum operations to be performed on multiple qubits; and generating a shortened quantum circuit including quantum operations smaller in number than the quantum operations included in the reference quantum circuit, where the shortened quantum circuit is so evaluated that a probability distribution obtained when quantum operations by the shortened quantum circuit are performed on the multiple qubits approximates to a probability distribution obtained when quantum operations by the reference quantum circuit are performed on the multiple qubits.

According to this aspect, the shortened quantum circuit smaller in the number of quantum operations than the reference quantum circuit that executes a desired quantum algorithm can be generated to obtain the probability distribution approximate to the probability distribution obtained when quantum operations are performed by the reference quantum circuit to measure the multiple qubits, and computation results similar to those of such a quantum algorithm as to require many quantum gate operations on a NISQ device can be obtained.

### BRIEF DESCRIPTION OF DRAWINGS

FIG. 1 is a diagram illustrating functional blocks of a quantum circuit generation device according to an embodiment of the present invention.

FIG. 2 is a diagram illustrating the physical configuration of the quantum circuit generation device according to the present embodiment.

FIG. 3 is a diagram illustrating an example of a reference quantum circuit set by the quantum circuit generation device according to the present embodiment.

FIG. 4 is a diagram illustrating an example of a shortened quantum circuit generated by the quantum circuit generation device according to the present embodiment.

FIG. 5 is a chart illustrating simulation results of probability distributions obtained when different quantum states are transformed respectively by the reference quantum circuit and the shortened quantum circuit generated by the quantum circuit generation device according to the present embodiment.

FIG. 6 is a chart illustrating a theoretical solution of a probability distribution obtained when predetermined quantum states are transformed by the reference quantum circuit, a probability distribution obtained by a quantum computer when the predetermined quantum states are transformed by the reference quantum circuit, and a probability distribution obtained by the quantum computer when the predetermined quantum states are transformed by the shortened quantum circuit generated by the quantum circuit generation device according to the present embodiment.

FIG. 7 is a graph illustrating simulation results of the degree of coincidence between a probability distribution obtained when various quantum states are transformed by the shortened quantum circuit generated by the quantum circuit generation device according to the present embodiment, and a theoretical solution of the probability distribution.

FIG. 8 is a graph illustrating simulation results of the degree of coincidence between a probability distribution obtained when various quantum states are transformed by a quantum circuit generated at random, and a theoretical solution of the probability distribution.

FIG. 9 is a graph illustrating actual measurement results of the degree of coincidence between a probability distribution obtained by the quantum computer when various quantum states are transformed by the reference quantum circuit, and a theoretical solution of the probability distribution.

FIG. 10 is a graph illustrating actual measurement results of the degree of coincidence between a probability distribution obtained by the quantum computer when various quantum states are transformed by the shortened quantum circuit generated by the quantum circuit generation device according to the present embodiment, and a theoretical solution of the probability distribution.

FIG. 11 is an example of a flowchart of quantum circuit generation processing executed by the quantum circuit generation device according to the present embodiment.

FIG. 12 is an example of a flowchart of Monte Carlo Tree Search processing executed by the quantum circuit generation device according to the present embodiment.

FIG. 13 is an example of a flowchart of learning processing executed by the quantum circuit generation device according to the present embodiment.

### DESCRIPTION OF EMBODIMENT

An embodiment of the present invention will be described with reference to the accompanying drawings. Note that elements given the same reference numerals in respective drawings have the same or similar configurations.

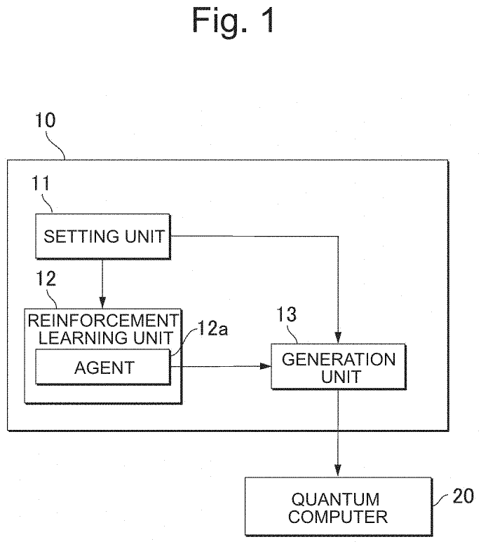

FIG. 1 is a diagram illustrating functional blocks of a quantum circuit generation device 10 according to this embodiment of the present invention. The quantum circuit generation device 10 includes a setting unit 11, a reinforcement learning unit 12, and a generation unit 13. A quantum computer 20 configures qubits by any hardware (such as a superconducting quantum circuit or an optical quantum circuit) to perform quantum computation by performing quantum gate operations on the qubits. The quantum computer 20 performs quantum computation based on a quantum circuit generated by the quantum circuit generation device 10. Note that the quantum computer 20 may also be included in the quantum circuit generation device 10.

The setting unit 11 sets a reference quantum circuit including multiple quantum operations to be performed on multiple qubits. The reference quantum circuit is a quantum circuit to execute a desired quantum algorithm, and the multiple quantum operations are represented by multiple quantum gates. The reference quantum circuit may include the processes of initialization and measurement of multiple qubits. The quantum algorithm executed by the reference quantum circuit may be a so-called long-term algorithm including Quantum Fourier Transform, Quantum Phase Estimation, Grover's search algorithm, Shor's factoring algorithm, and the like, which may not be a so-called near-term algorithm including a Variational Quantum Eigensolver method, a Quantum Approximation Optimization method, quantum circuit learning, and the like.

The generation unit 13 generates a shortened quantum circuit including quantum operations smaller in number than the quantum operations included in the reference quantum circuit, where the shortened quantum circuit is so evaluated that a probability distribution obtained when quantum operations by the shortened quantum circuit are performed on multiple qubits approximates to a probability distribution obtained when quantum operations by the reference quantum circuit are performed on the multiple qubits. Here, the number of quantum operations may be the number of quantum gates. However, for example, when qubits are configured by a superconducting circuit, the number of times to apply high-frequency pulses to a resonator or the like may be determined to be the number of quantum operations.

According to the quantum circuit generation device 10 of the present embodiment, the shortened quantum circuit smaller in the number of quantum operations than the reference quantum circuit that executes a desired quantum algorithm is so generated that a probability distribution approximate to a probability distribution obtained when quantum operations are performed by the reference quantum circuit to measure the multiple qubits can be obtained. As the number of quantum operations increases, the NISQ device is affected by noise more strongly to make it difficult to obtain a reliable solution. In this respect, according to the quantum circuit generation device 10 of the present embodiment, computation results similar to those of such a quantum algorithm as to require many quantum gate operations on the NISQ device.

The evaluation in the generation unit 13 may be made by generating multiple intermediate quantum circuits including quantum operations smaller in number than the quantum operations included in the reference quantum circuit, and exploring the shortened quantum circuit from among the multiple intermediate quantum circuits based on an evaluation function in which a probability distribution obtained when quantum operations by the multiple intermediate quantum circuits are performed on the multiple qubits and the number of quantum operations included in the multiple intermediate quantum circuits are set as variables. The fewer the number of quantum operations, the higher the evaluation in the evaluation function, and the evaluation becomes higher as the degree of coincidence between the probability distribution obtained when quantum operations are performed by the reference quantum circuit to measure the multiple qubits and the probability distribution obtained when quantum operations are performed by the intermediate quantum circuits to measure the multiple qubits increases. Thus, the desired quantum algorithm can be executed more accurately by a shorter quantum circuit on the NISQ device.

The reinforcement learning unit 12 generates an agent 12a by reinforcement learning to output one or more quantum operations to be performed on the multiple qubits to obtain a probability distribution approximate to the probability distribution obtained when quantum operations by the reference quantum circuit are performed on the multiple qubits. At this time, the generation unit 13 generates the shortened quantum circuit based on the one or more quantum operations output by the agent 12a.

The reinforcement learning unit 12 generates the agent 12a by setting, as state, the one or more quantum operations performed on the multiple qubits, setting, as action, quantum operations to be performed on the multiple qubits, and calculating a reward based on the degree of coincidence between the probability distribution when quantum operations by the reference quantum circuit are performed on the multiple qubits and the probability distribution when the one or more quantum operations obtained as a result of action are performed on the multiple qubits. Although the number of combinations of quantum operations capable of being approximate to the reference quantum circuit is huge, a proper combination of quantum operations can be explored efficiently by using reinforcement learning. The degree of coincidence may be calculated between a probability distribution obtained by simulating the case where quantum operations by the reference quantum circuit are performed on the multiple qubits, and a probability distribution obtained by simulating the case where quantum operations by the shortened quantum circuit are performed on the multiple qubits. However, the degree of coincidence may also be calculated between the probability distribution obtained by simulating the case where quantum operations by the reference quantum circuit are performed on the multiple qubits, and a probability distribution obtained when quantum operations by the shortened quantum circuit are performed on the multiple qubits by the NISQ device. Use of the actual measurement results by the NISQ device can calculate the degree of coincidence that reflects the quantum operation results by the shortened quantum circuit more accurately, and hence a more proper reward can be calculated.

Based on the reward calculated by comparing the degree of coincidence with a threshold value, the generation unit 13 may determine whether or not to end the selection of action by the agent 12a. For example, the generation unit 13 may set the reward to +1 when the degree of coincidence is equal to or more than the threshold value, and set the reward to 0 when the degree of coincidence is less than the threshold value. In this case, the generation unit 13 may determine to end the selection of action by the agent 12a when the reward is +1, and determine to continue the selection of action by the agent 12a when the reward is 0. However, even when the reward is 0, the selection of action may also be ended if the number of quantum operations included in state reaches a predetermined number of times. This can generate a relatively short quantum circuit while sufficiently increasing the degree of coincidence.

The degree of coincidence may also be given as a function in which the probability distribution obtained when quantum operations by the reference quantum circuit are performed on the multiple qubits and the probability distribution obtained when the one or more quantum operations selected as action are performed on the multiple qubits are set as variables. Specifically, this function may include Kolmogorov distance expressed in Formula (1) and Bhattacharyya coefficient or Kullback-Leibler divergence expressed in Formula (2). Here, p₀ is the probability distribution obtained when quantum operations by the reference quantum circuit are performed on the multiple qubits, p₁ is the probability distribution obtained when the one or more quantum operations selected as action are performed on the multiple qubits, and X is a set of observable qubit values.

$$K ( {p}_{0} , {p}_{1} ) ≡ \frac{1}{2} {\sum }_{x ∈ X} \vert {p}_{0} ( x ) - {p}_{1} ( x ) \vert \qquad [ Math . 1 ]$$

$$B ( {p}_{0} , {p}_{1} ) ≡ {\sum }_{x ∈ X} \sqrt{{p}_{0} ( x ) {p}_{1} ( x )} \qquad [ Math . 2 ]$$

Kolmogorov distance K(p₀, p₁) and Bhattacharyya coefficient B(p₀, p₁) are bounded functions that take values of not less than 0 and not more than 1, and 1-K(p₀, p₁) and B(p₀, p₁) become 1 when the two probability distributions p₀ and p₁ match up with each other. Use of such functions results in properly setting the reward of reinforcement learning and facilitating the progress of learning.

The reinforcement learning agent may select action using Monte Carlo Tree Search. The details of Monte Carlo Tree Search will be described later with reference to a drawing. The selection of action using Monte Carlo Tree Search can generate quantum gate operation sequences shorter than those capable of obtaining a probability distribution approximate to the probability distribution obtained when quantum operations by the reference quantum circuit are performed on the multiple qubits.

The reinforcement learning agent may also perform Monte Carlo Tree Search based on output values obtained by inputting the state to a neural network. Here, the neural network may be to output, using the state as input, an evaluation value of the state and a probability at which a specific action is selected in the state. Thus, quantum gate operation sequences shorter than those capable of obtaining the probability distribution approximate to the probability distribution obtained when quantum operations by the reference quantum circuit are performed on the multiple qubits can be generated more efficiently.

Based on learning data obtained by simulating the selection of action using Monte Carlo Tree Search and the calculation of the reward multiple times, the generation unit 13 may update parameters of the neural network. Thus, the state can be evaluated more properly by the neural network, and hence proper action can be selected.

The generation unit 13 may also calculate the reward based on the degree of coincidence and the number of one or more quantum operations included in the state. For example, the generation unit 13 may calculate the reward in such a manner that the reward becomes higher as the degree of coincidence increases, and that the reward becomes higher as the number of one or more quantum operations decreases. Thus, the agent to generate a shorter quantum circuit with a higher degree of coincidence can be generated by reinforcement learning.

When qubits are configured by a superconducting quantum circuit, the generation unit 13 may generate a microwave pulse to realize each individual quantum operation included in the shortened quantum circuit. In this case, the reinforcement learning unit 12 may generate the agent 12a by setting, as state, a series of microwave pulses to realize the one or more quantum operations performed on the multiple qubits, setting, as action, microwave pulses that realize quantum operations to be performed on the multiple qubits, and calculating the reward based on the degree of coincidence between the probability distribution obtained when quantum operations by the reference quantum circuit are performed on the multiple qubits, and the probability distribution obtained when the one or more quantum operations selected as action are performed on the multiple qubits.

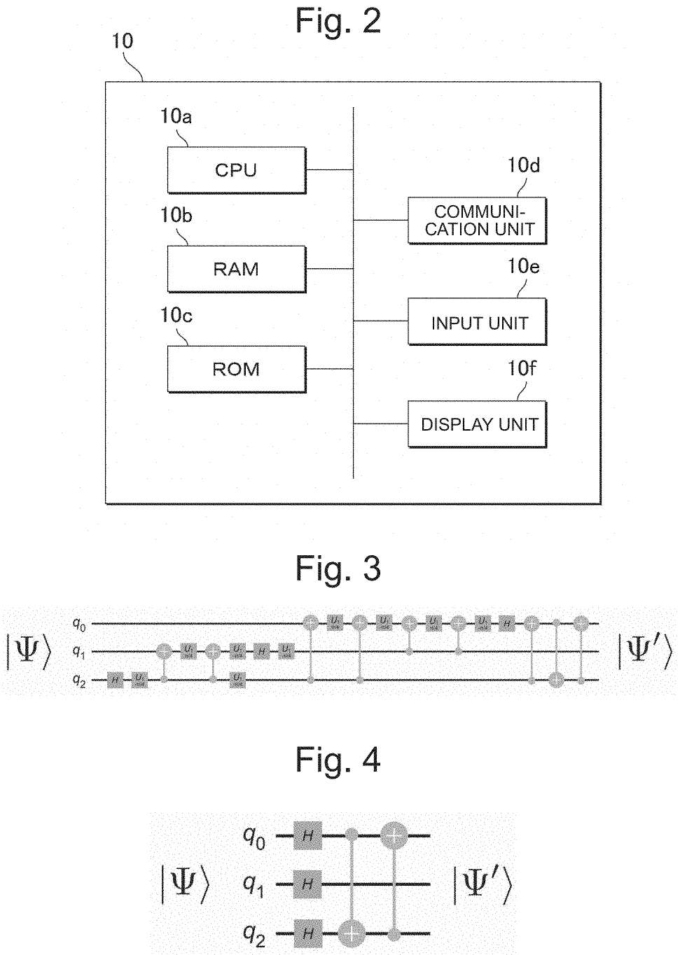

FIG. 2 is a diagram illustrating the physical configuration of the quantum circuit generation device 10 according to the present embodiment. The quantum circuit generation device 10 has a CPU (Central Processing Unit) 10a corresponding to an arithmetic unit, a RAM (Random Access Memory) 10b corresponding to a storage unit, a ROM (Read Only Memory) 10c corresponding to another storage unit, a communication unit 10d, an input unit 10e, and a display unit 10f. These components are connected to one another through a bus in a manner to be able to send and receive data from and to one another. Note that description will be made when the quantum circuit generation device 10 is constructed by one computer in this example, but the quantum circuit generation device 10 may also be realized by a combination of two or more computers. Further, the configuration illustrated in FIG. 2 is just an example, and the quantum circuit generation device 10 may also have any component(s) other than those in FIG. 2, or may not have some of these components. For example, the quantum circuit generation device 10 may also include the physical configuration of the quantum computer 20.

The CPU 10a is a control unit that performs control related to the execution of a program stored in the RAM 10b or the ROM 10c, and arithmetic operation and processing of data. The CPU 10a is an arithmetic unit to execute a program (quantum circuit generation program) that generates the shortened quantum circuit. The CPU 10a receives various data from the input unit 10e and the communication unit 10d to display data computation results on the display unit 10f and store the data computation results in the RAM 10b.

The RAM 10b is data rewritable one of the storage units, which may be composed of semiconductor memory elements. The RAM 10b may store the quantum circuit generation program executed by the CPU 10a, learning data used for deep reinforcement learning, and the like. Note that these data are just an example, and any other data may be stored in the RAM 10b, or some of these data may not be stored in the RAM 10b.

The ROM 10c is data readable one of the storage units, which may be composed of semiconductor memory elements. For example, the ROM 10c may store the quantum circuit generation program and data that are not rewritten.

The communication unit 10d is an interface to connect the quantum circuit generation device 10 to other devices. The communication unit 10d may be connected to a communication network such as the Internet.

The input unit 10e is to accept input of data from a user, which may include a keyboard and a touch panel, for example.

The display unit 10f is to visually display computation results by the CPU 10a, which may be configured by an LCD (Liquid Crystal Display), for example. The display unit 10f may also display a generated quantum circuit.

The quantum circuit generation program may be stored on a computer-readable storage medium, such as the RAM 10b or the ROM 10c, and provided, or may be provided through the communication network connected by the communication unit 10d. In the quantum circuit generation device 10, the operation of the setting unit, the reinforcement learning unit, and the generation unit described with reference to FIG. 1 is implemented by the CPU 10a executing the quantum circuit generation program. Note that these physical components are just an example, and do not necessarily have to be independent components. For example, the quantum circuit generation device 10 may include an LSI (Large-Scale Integration) in which the CPU 10a, the RAM 10b, and the ROM 10c are united. Further, the quantum circuit generation device 10 may also include a GPU (Graphical Processing Unit) or an ASIC (Application Specific Integrated Circuit).

FIG. 3 is a diagram illustrating an example of the reference quantum circuit set by the quantum circuit generation device 10 according to the present embodiment. In this figure, such a quantum circuit that makes some of Hadamard gates H, π/4 gates U_{1 π/4}, −π/4 gates U_{1 -π/4}, and control NOT gates act on initial state |Ψ> including first qubit q₀, second qubit q₁, and third qubit q₂ in a given order to obtain final state |Ψ′> is illustrated. In this case, a probability distribution of measurement values of (q₀, q₁, q₂) is calculated by p(q₀, q₁, q₂)=|<q₀, q₁, q₂|Ψ′>|². The reference quantum circuit illustrated in this example is a quantum circuit that executes Quantum Fourier Transform, which includes 21 quantum gate operations.

FIG. 4 is a diagram illustrating an example of the shortened quantum circuit generated by the quantum circuit generation device 10 according to the present embodiment. In this figure, such a quantum circuit that makes some of Hadamard gates H, π/4 gates U_{1 π/4}, −π/4 gates U_{1 -π/4}, and control NOT gates act on initial state |Ψ> including first qubit q₀, second qubit q₁, and third qubit q₂ in a given order to obtain final state |Ψ′> is illustrated. In this case, a probability distribution of measurement values of (q₀, q₁, q₂) is also calculated by p(q₀, q₁, q₂)=|<q₀, q₁, q₂|Ψ′>|². The shortened quantum circuit illustrated in this example is a quantum circuit that approximates to the reference quantum circuit, which includes five quantum gate operations. The number of quantum gates included in the shortened quantum circuit in this example is smaller than the number of quantum gates included in the reference quantum circuit, which is about ¼.

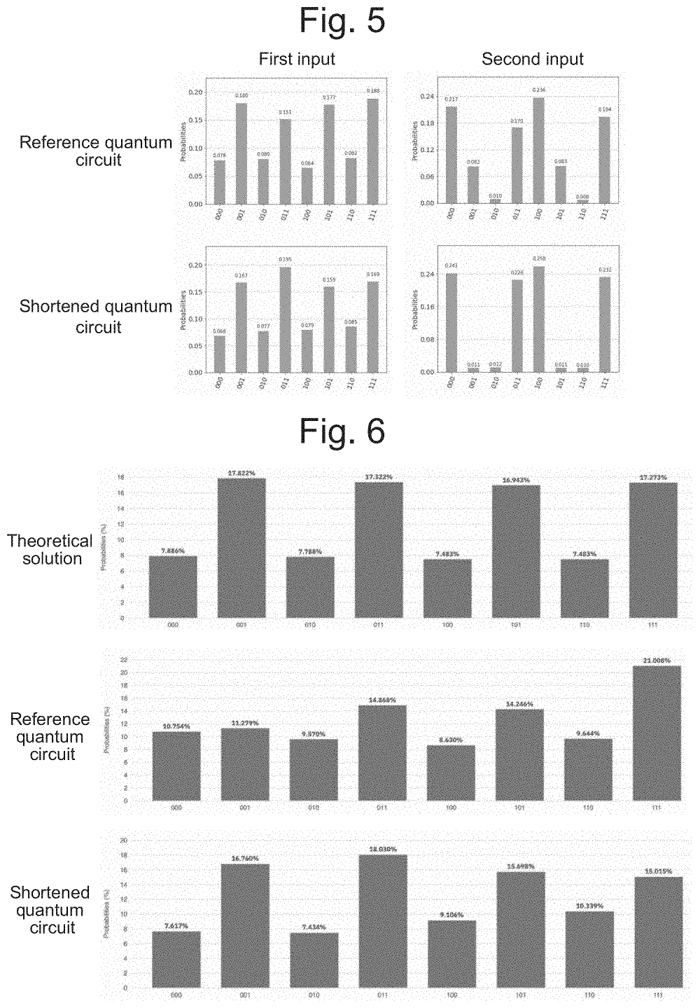

FIG. 5 is a chart illustrating simulation results of probability distributions obtained when different quantum states are transformed respectively by the reference quantum circuit and the shortened quantum circuit generated by the quantum circuit generation device 10 according to the present embodiment. In this figure, the simulation result of a probability distribution of qubits measured when first input (first quantum state) is input to the reference quantum circuit, and the simulation result of a probability distribution of qubits measured when first input (first quantum state) is input to the shortened quantum circuit are illustrated in the left column. Further, the simulation result of a probability distribution of qubits measured when second input (second quantum state) is input to the reference quantum circuit, and the simulation result of a probability distribution of qubits measured when second input (second quantum state) is input to the shortened quantum circuit are illustrated in the right column. As illustrated in this figure, the probability distributions obtained when different quantum states are transformed respectively by the reference quantum circuit and the shortened quantum circuit approximate to each other. Note that the simulation results of probability distributions obtained when two types of quantum states are transformed respectively by the reference quantum circuit and the shortened quantum circuit are illustrated, but even when three or more types of various quantum states are input, similarly approximate probability distributions can be obtained.

FIG. 6 is a chart illustrating a theoretical solution of a probability distribution obtained when predetermined quantum states are transformed by the reference quantum circuit, a probability distribution obtained by the quantum computer 20 when the predetermined quantum states are transformed by the reference quantum circuit, and a probability distribution obtained by the quantum computer 20 when the predetermined quantum states are transformed by the shortened quantum circuit generated by the quantum circuit generation device 10 according to the present embodiment. In this figure, the probability distributions obtained when the quantum states are transformed by the reference quantum circuit and the shortened quantum circuit are actual measurement results by actually setting the reference quantum circuit and the shortened quantum circuit on the quantum computer 20, respectively. Note that the quantum computer 20 is the NISQ device, which cannot remove the effects of noise.

The degree of coincidence of the probability distribution, obtained by the quantum computer 20 when the predetermined quantum states are transformed by the reference quantum circuit, with the theoretical solution of the probability distribution is low. Specifically, plural peaks in the probability distribution are collapsed and become smoother to approach a uniform distribution. This is because the probability distribution is strongly affected by noise in the process of performing 21 quantum gate operations and hence unintentionally disturbed.

The degree of coincidence of the probability distribution, obtained by the quantum computer 20 when the predetermined quantum states are transformed by the shortened quantum circuit, with the theoretical solution of the probability distribution is high. Specifically, plural peaks in the probability distribution appear correctly, and similar peaks to those in the theoretical solution are reproduced. This is because the shortened quantum circuit includes only five quantum gate operations, and hence is less susceptible to the effects of noise. Thus, use of the shortened quantum circuit approximate to the reference quantum circuit can obtain a probability distribution more approximate to the theoretical solution than use of the reference quantum circuit.

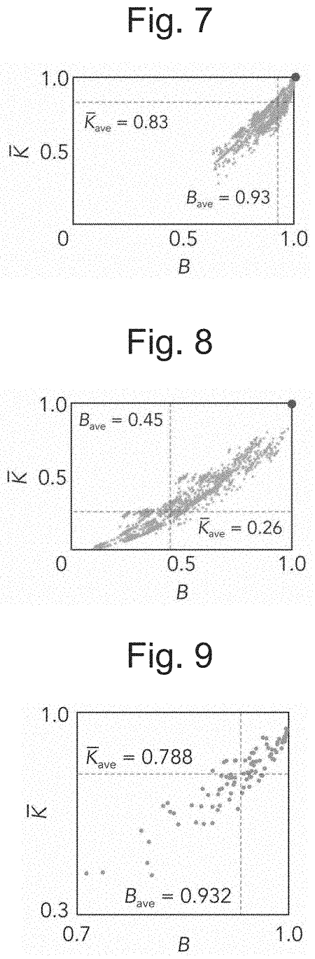

FIG. 7 is a graph illustrating a simulation result of the degree of coincidence between a probability distribution obtained when various quantum states are transformed by the shortened quantum circuit generated by the quantum circuit generation device 10 according to the present embodiment, and a theoretical solution of the probability distribution. In this figure, as the degree of coincidence, Bhattacharyya coefficient B expressed in Formula 2 is taken on the horizontal axis, and Kolmogorov scale K⁻ (=1−K) expressed in Formula 1 is taken on the vertical axis. When the probability distributions match exactly, B=K⁻=1.

According to the simulation result, the Bhattacharyya coefficient average is Bₐᵥₑ=0.93, and the Kolmogorov scale average is K⁻ₐᵥₑ=0.83.

FIG. 8 is a graph illustrating a simulation result of the degree of coincidence between a probability distribution obtained when various quantum states are transformed by a quantum circuit generated at random, and a theoretical solution of the probability distribution. In this figure, like in FIG. 7, as the degree of coincidence, Bhattacharyya coefficient B expressed in Formula 2 is taken on the horizontal axis, and Kolmogorov scale K⁻ (=1−K) expressed in Formula 1 is taken on the vertical axis.

According to the simulation result, when the quantum circuit generated at random is used, the Bhattacharyya coefficient average is Bₐᵥₑ=0.45, and the Kolmogorov scale average is K⁻ₐᵥₑ=0.26. Thus, the theoretical solution of the probability distribution obtained when quantum states are transformed by the reference quantum circuit can be reproduced accurately by using the shortened quantum circuit generated by the quantum circuit generation device 10 according to the present embodiment.

FIG. 9 is a graph illustrating actual measurement results of the degree of coincidence between a probability distribution obtained by the quantum computer 20 when various quantum states are transformed by the reference quantum circuit, and a theoretical solution of the probability distribution. In this figure, like in FIG. 7, as the degree of coincidence, Bhattacharyya coefficient B expressed in Formula 2 is taken on the horizontal axis, and Kolmogorov scale K⁻ (=1−K) expressed in Formula 1 is taken on the vertical axis. Each point illustrated in this figure represents the degree of coincidence calculated by actually measuring the probability distribution obtained by setting the reference quantum circuit in the quantum computer 20 and transforming various quantum states.

According to the actual measurement results, when the reference quantum circuit is set in the quantum computer 20, the Bhattacharyya coefficient average is Bₐᵥₑ=0.932, and the Kolmogorov scale average is K⁻ₐᵥₑ=0.788.

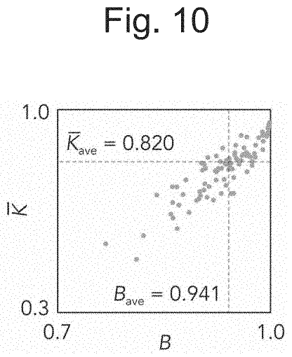

FIG. 10 is a graph illustrating actual measurement results of the degree of coincidence between a probability distribution obtained by the quantum computer 20 when various quantum states are transformed by the shortened quantum circuit generated by the quantum circuit generation device 10 according to the present embodiment, and a theoretical solution of the probability distribution. In this figure, like in FIG. 7, as the degree of coincidence, Bhattacharyya coefficient B expressed in Formula 2 is taken on the horizontal axis, and Kolmogorov scale K⁻ (=1−K) expressed in Formula 1 is taken on the vertical axis. Each point illustrated in this figure represents the degree of coincidence calculated by actually measuring the probability distribution obtained by setting the shortened quantum circuit in the quantum computer 20 and transforming various quantum states.

According to the actual measurement results, when the shortened quantum circuit is set in the quantum computer 20, the Bhattacharyya coefficient average is Bₐᵥₑ=0.941, and the Kolmogorov scale average is K⁻ₐᵥₑ=0.820. Thus, it can also be confirmed from the point of view of the degree of coincidence that use of the shortened quantum circuit on the quantum computer 20 can obtain a probability distribution closer to the theoretical solution than use of the reference quantum circuit.

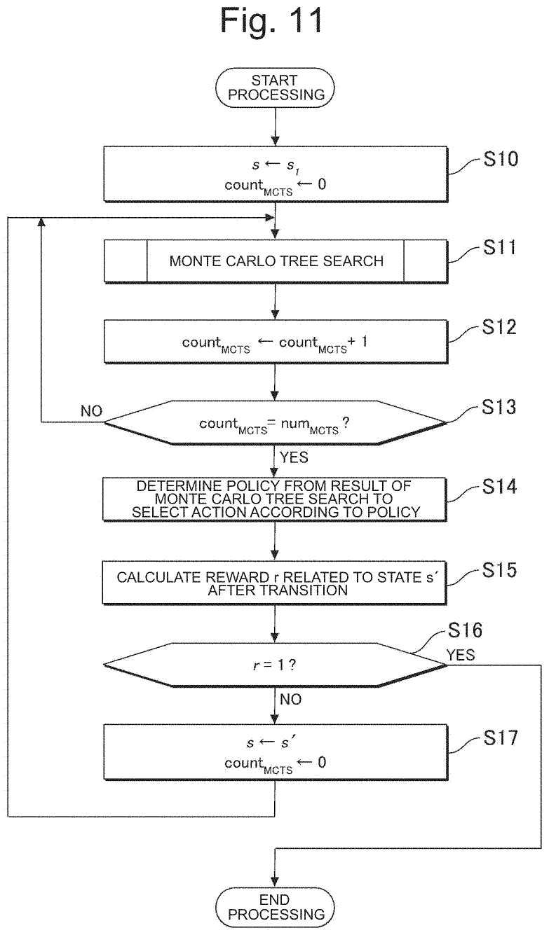

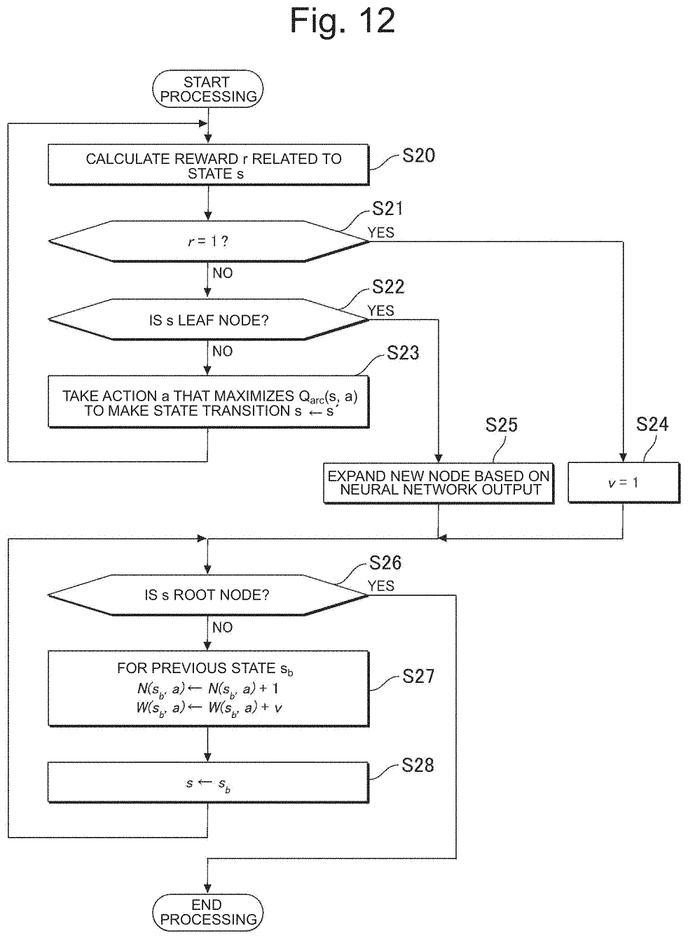

FIG. 11 is an example of a flowchart of quantum circuit generation processing executed by the quantum circuit generation device 10 according to the present embodiment. In this example, processing to generate the shortened quantum circuit using deep reinforcement learning is illustrated. First, the circuit generation device 10 sets state s of reinforcement learning to initial state s₁ to initialize counter count_{MCTS} of Monte Carlo Tree Search (MCTS) to 0 (S10).

After that, the quantum circuit generation device 10 executes Monte Carlo Tree Search (S11) to increment the counter count_{MCTS} by one (S12). Then, when the counter count_{MCTS} does not reach a predetermined number of times num_{MCTS} (S13: NO), the processes S11 and S12 are repeatedly executed. Note that the details of Monte Carlo Tree Search will be described with reference to the next drawing.

When the counter count_{MCTS} reaches the predetermined number of times num_{MCTS} (S13: YES), a policy is determined from the result of Monte Carlo Tree Search to select action according to the policy (S14). Here, when the number of visits at nodes related to state s and action a in Monte Carlo Tree Search is expressed as N(s, a), policy π(s, a) may be defined as π(s, a)∝N(s, a).

After that, the quantum circuit generation device 10 calculates reward r related to state s′ after transition (S15). In a case where the degree of coincidence between a probability distribution, obtained when quantum states are transformed using one or more quantum operations included in the state s′ after transition, and a probability distribution of the theoretical solution is equal to or more than a threshold value, the reward r may be calculated as 1, and in the other cases, the reward r may be calculated as 0.

When the reward r is 1 (S16: YES), the quantum circuit generation device 10 ends the processing, and outputs, as the shortened quantum circuit, the one or more quantum operations included in the state s′ after transition. On the other hand, when the reward r is not 1 (S16: NO), the state is updated from s to s′ and the counter count_{MCTS} is initialized to 0 (S17), and the process S11 and subsequent processes are repeatedly executed.

FIG. 12 is an example of a flowchart of Monte Carlo Tree Search processing executed by the quantum circuit generation device 10 according to the present embodiment. First, the quantum circuit generation device 10 calculates a reward r related to state s (S20). Then, when r=1 (S21: YES), V(s)=1 is set (S24). On the other hand, when the reward r is not r=1 (S21: NO) and the state s is a leaf node (S22: YES), a new node is expanded based on output obtained by inputting state s to the neural network (S25). Here, the output of the neural network may include value V(s) of the state s and a probability P(s, a) of selecting action a in the state s.

On the other hand, when the reward r is not r=1 (S21: NO) and the state s is not a leaf node (S22: NO), action a that maximizes Q_{arc}(s, a) is taken, the transition of the state from s to s′ is made (S23), and the process S20 and subsequent processes are repeatedly executed. Here, Q_{arc}(s, a)=Q(s, a)+U(s, a), which is defined by Q(s, a)=Σ_{s′|s, a→s′}V(s′)/N(s, a), U(s, a)=c_{puct}P(s, a)√Σ_{b}N(s, b)/(1+N(s, a)).

When the state s is not a root node after the process S24 or S25 is executed (S26: NO), the quantum circuit generation device 10 increments N(s_{b}, a) related to the previous state s_{b} by one, and increments W(s_{b}, a) by V(s) (S27). Note that Q(s, a)=W(s, a)/N(s, a). Further, the quantum circuit generation device 10 makes a reverse transition of the state from s to s_{b} (S28), and repeatedly executes the process S26 and subsequent processes.

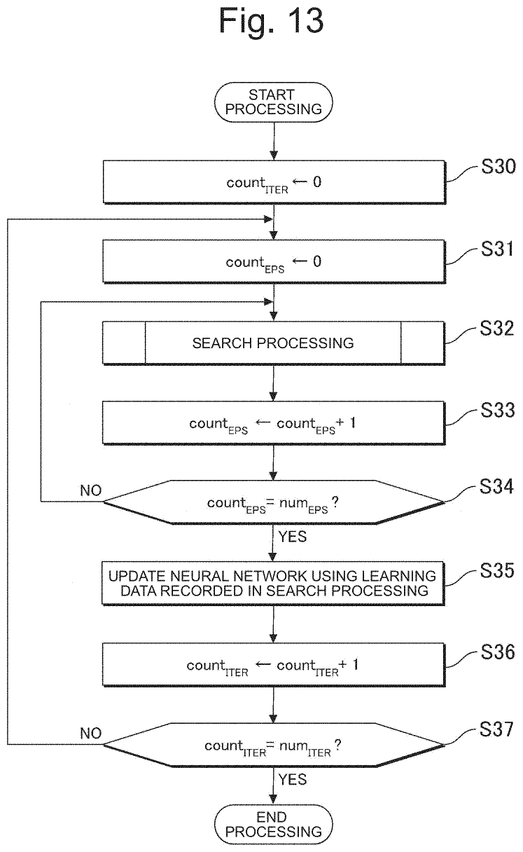

FIG. 13 is an example of a flowchart of learning processing executed by the quantum circuit generation device 10 according to the present embodiment. First, the quantum circuit generation device 10 initializes counter count_{ITER} to 0 (S30), and initializes counter count_{EPS} to 0 (S31).

Next, the quantum circuit generation device 10 executes the search processing illustrated in FIG. 11 (S32), and increments the counter count_{EPS} by one (S33). Then, when the counter count_{EPS} does not reach a predetermined number of times num_{EPS} (S34: NO), the quantum circuit generation device 10 repeatedly executes the processes S32 and S33. The quantum circuit generation device 10 accumulates neural network learning data by so-called self-play thus performed. Note that the self-play may be performed by simulating quantum operations by a classical arithmetic circuit included in the quantum circuit generation device 10, or may be performed using actual measurement results by the quantum computer 20.

The quantum circuit generation device 10 updates parameters of the neural network using learning data recorded in the search processing. Specifically, the quantum circuit generation device 10 records state s, policy π, and reward z by the search processing to update the neural network parameters by a backpropagation method in such a manner as to minimize a loss function L=(z−v)²−π log(p) about neural network outputs v and p. A regularization term to prevent overlearning of the neural network may also be added to the loss function.

After that, the quantum circuit generation device 10 increments the counter count_{ITER} by one (S36), and when the counter count_{ITER} does not reach a predetermined number of times num_{ITER} (S37: NO), the quantum circuit generation device 10 repeatedly executes the processes S31 to S36.

The embodiment described above is to make easy to understand the present invention, and is not intended to limit the interpretation of the present invention. Each element, the arrangement, material, condition, shape, and size of the element, and the like included in the embodiment are not limited to those illustrated, and changes can be made appropriately. Further, configurations illustrated in different embodiments can be partially replaced or combined.

### REFERENCE SIGNS LIST

10 . . . quantum circuit generation device, 10a . . . CPU, 10b . . . RAM, 10c . . . ROM, 10d . . . communication unit, 10e . . . input unit, 10f . . . display unit, 11 . . . setting unit, 12 . . . reinforcement learning unit, 12a . . . agent, 13 . . . generation unit, 20 . . . quantum computer.

1. A quantum circuit generation device comprising:
a setting unit which sets a reference quantum circuit including a plurality of quantum operations to be performed on a plurality of qubits; and
a generation unit which generates a shortened quantum circuit including quantum operations smaller in number than the quantum operations included in the reference quantum circuit, where the shortened quantum circuit is so evaluated that a probability distribution obtained when quantum operations by the shortened quantum circuit are performed on the plurality of qubits approximates to a probability distribution obtained when quantum operations by the reference quantum circuit are performed on the plurality of qubits.

2. The quantum circuit generation device according to claim 1, wherein the evaluation in the generation unit is made by
generating a plurality of intermediate quantum circuits including quantum operations smaller in number than the quantum operations included in the reference quantum circuit, and
exploring the shortened quantum circuit from among the plurality of intermediate quantum circuits based on an evaluation function in which a probability distribution obtained when quantum operations by the plurality of intermediate quantum circuits are performed on the plurality of qubits, and the number of quantum operations included in the plurality of intermediate quantum circuits are set as variables.

3. The quantum circuit generation device according to claim 1, further comprising
a reinforcement learning unit which generates an agent by reinforcement learning to output one or more quantum operations to be performed on the plurality of qubits so as to obtain a probability distribution that approximates to a probability distribution obtained when quantum operations by the reference quantum circuit are performed on the plurality of qubits, wherein
the generation unit generates the shortened quantum circuit based on the one or more quantum operations output by the agent, and
the reinforcement learning unit generates the agent by
setting one or more quantum operations performed on the plurality of qubits as state,
setting quantum operations to be performed on the plurality of qubits as action, and
calculating a reward based on a degree of coincidence between a probability distribution obtained when quantum operations by the reference quantum circuit are performed on the plurality of qubits, and a probability distribution obtained when the one or more quantum operations selected as the action are performed on the plurality of qubits.

4. The quantum circuit generation device according to claim 3, wherein the generation unit determines whether or not to end the selection of the action by the agent based on the reward calculated by comparing the degree of coincidence with a threshold value.

5. The quantum circuit generation device according to claim 3, wherein the degree of coincidence is given as a function in which a probability distribution obtained when quantum operations by the reference quantum circuit are performed on the plurality of qubits, and a probability distribution obtained when the one or more quantum operation selected as the action are performed on the plurality of qubits are set as variables.

6. The quantum circuit generation device according to claim 5, wherein the function includes Kolmogorov distance or Bhattacharyya coefficient.

7. The quantum circuit generation device according to claim 3, wherein the agent selects the action using Monte Carlo Tree Search.

8. The quantum circuit generation device according to claim 7, wherein the agent performs the Monte Carlo Tree Search based on output values obtained by inputting the state to a neural network.

9. The quantum circuit generation device according to claim 8, wherein the generation unit updates parameters of the neural network based on learning data obtained by simulating selection of the action using the Monte Carlo Tree Search and calculation of the reward a plurality of times.

10. The quantum circuit generation device according to claim 3, wherein the generation unit calculates the reward based on the degree of coincidence and the number of one or more quantum operations included in the state.

11. A quantum circuit generation method comprising:
setting a reference quantum circuit including a plurality of quantum operations to be performed on a plurality of qubits; and
generating a shortened quantum circuit including quantum operations smaller in number than the quantum operations included in the reference quantum circuit, where the shortened quantum circuit is so evaluated that a probability distribution obtained when quantum operations by the shortened quantum circuit are performed on the plurality of qubits approximates to a probability distribution obtained when quantum operations by the reference quantum circuit are performed on the plurality of qubits.

12. A quantum circuit generation program causing a classical arithmetic circuit included in a quantum circuit generation device to execute:
setting a reference quantum circuit including a plurality of quantum operations to be performed on a plurality of qubits; and
generating a shortened quantum circuit including quantum operations smaller in number than the quantum operations included in the reference quantum circuit, where the shortened quantum circuit is so evaluated that a probability distribution obtained when quantum operations by the shortened quantum circuit are performed on the plurality of qubits approximates to a probability distribution obtained when quantum operations by the reference quantum circuit are performed on the plurality of qubits.
